(19) United States
(12) Patent Application Publication
(10) Pub. No.: US 2006/0080291 A1
(43) Pub. Date: Apr. 13, 2006

(54) Package stock management method and device

(76) Inventors: Masao Murata, Kawasaki (JP); Keizo Hirano, Kawasaki (JP); Satoshi Kumano, Kawasaki (JP); Hideki Maeda, Kawasaki (JP); Norio Iijima, Kawasaki (JP); Makoto Kobata, Kawasaki (JP); Kiyofumi Hara, Kawasaki (JP)

Correspondence Address: KATTEN MUCHIN ROSENMAN LLP, 575 MADISON AVENUE, NEW YORK, NY, 10022-2585, US

(21) Appl. No.: 10/974,479

(22) Filed: Oct. 27, 2004

(30) Foreign Application Priority Data
May 10, 2004 (JP) 2004-140060

(51) Int. Cl. G06F 17/30

(52) U.S. Cl. 707/3

(57) ABSTRACT

A package stock management method and device for an operator to register (provisioning-setting) a new service in a service offering device, wherein upon reception of a provisioning setting request of a service to a desired service offering device, a package having a necessary function for offering the service is retrieved from stock information set in a first database; proper information of the retrieved package as provisioning information is set in a second database; and, at the time when the retrieved package is forwarded and mounted on the service offering device, the provisioning information is set in the mounted package.

### BACKGROUND OF THE INVENTION

1. Field of the Invention

The present invention relates to a package stock management method and device, and in particular to a package stock management method and device for a package which is mounted on, or installed in a network element (NE) forming a network and offering services for the network.

2. Description of the Related Art

Conventionally, a package stock management system for network elements as a service offering device is provided separately from a network management system (NMS) managing network elements, in which service registration information from the network management system and access information of the package stock management system for the network elements are managed with different databases. It is to be noted that in the following description, “service registration” will be referred to as “service setting” or “service provisioning setting” for the same meaning.

Upon registering a novel or new service in the network management system, an operator retrieves a stock package from the database of the package stock management system, performs a forwarding operation of the package, that is, takes the package out of a storehouse, in the presence of the stock package, and sets, after having mounted the package on the network element, service provisioning information to the package in the network element having mounted the package from the network management system. In the absence of the stock package, the operator performs a storing operation, that is, puts a package into a storehouse, and performs a storing setting to the package stock management system at the time when the package is stored in the package storehouse.

Besides, there is proposed a service order operation system in which electronic computer systems are mutually and hierarchically coupled to assign and manage communication service items, node equipments that are the parts thereof, subscriber line equipments, and other logic/physical resources, each system being provided with a resource request means, a resource stock management means for managing the communication service items and the stock number of the resources, and a resource stock information database, the resource stock management means being provided with a simulation means for calculating the kind and number of necessary resources (see e.g. patent document 1).

Furthermore, there is proposed a stock management system and management method provided with a function by which DSM (exclusive service mode device) automatically monitors inserted status of a package, and position and type of the inserted package by a polling method, and using an exclusive service node device in which stock information is notified to network information terminal through a network element/operation system, and the occupation status of overall device is visually displayed on network information terminal by package accommodation position information and the presence/absence of the accommodation so that a presently offerable service type may be seen from the package type (see e.g. patent document 2).
[patent document 1] Japanese patent application laid-open No. 7-115477
[patent document 2] Japanese patent application laid-open No. 2002-259512

In the above noted prior art, the network management system and the package stock management system do not share mutually necessary electronic information. Therefore, upon registering a new service in the network management system, an operator of the network management system retrieves a package required by a network element from the package stock management system in order to offer a desired service, determines a package to be forwarded from the retrieval result, and sets provisioning information from the network management system in a package forwarded and mounted on the corresponding network element, which requires operator's works at least twice, consuming time.

It is also disadvantageous that such a package stock management system only manages the stock number and the access number of packages, and can not predict an accurate access number of the package associated with the service provisioning setting information, which produces a lacking stock package upon the service provisioning setting, with the result of an adverse effect on the service commencement as well as a large number of stock packages. Moreover, it is disadvantageous that no processing is done in the absence of stock packages in the package storehouse, with the result of a lacking stock and excess stock of packages.

Furthermore, it is disadvantageous that in the occurrence of alarms in a package mounted on the network elements, an operator only performs a maintenance service for a network affected, but can not specify the package having the same identifying information (for example, the same type), so that a common problem to the packages having the same identification information would cause frequent package alarms and an adverse effect on offering services in the network elements.

### SUMMARY OF THE INVENTION

It is accordingly an object of the present invention to provide a package stock management method and device in which for an operator to register (provisioning-setting) a new service in a service offering device, information required for retrievals is all electronified and shared, thereby shortning the time until the service commencement, eliminating a lacking stock status or an excessive stock status, and predicting a package with an alarm being generated to reduce the alarm status.

For the achievement of the above object, a package stock management method according to the present invention comprises; a first step of, upon reception of a provisioning setting request of a service to a desired service offering device, retrieving a package having a necessary function for offering the service from stock information set in a first database; a second step of setting proper information of the retrieved package as provisioning information in a second database; and a third step of, at the time when the retrieved package is forwarded and mounted on the service offering device, setting the provisioning information in the mounted package.

Namely in the present invention, as a precondition of the first step, the first database is preset with stock information. When a provisioning setting request (service registration request) of a service for a desired service offering device such as a network element is received from for example an operator of a network management system, a package having a function necessary for the desired service offering device is retrieved from the stock information in the first database.

At the second step, proper information of the package retrieved from the first database at the first step is set in the second database with being included in the provisioning information.

Then at the third step, when the package retrieved at the first step is forwarded and mounted on the service offering device by for example an operator, the provisioning information set in the second database at the second step is set in the package mounted on the service offering device.

Thus, only by for example an operator making a provisioning setting request of a service to a desired service offering device, a package necessary for the service offering device is retrieved, and when the retrieved package is mounted on the service offering device, the proper information of the package can be set in the mounted package with being included in the provisioning information, enabling the provisioning operation for a new service to be rapidly made.

When it is found at the first step that there are a plurality of corresponding packages retrieved upon an automatic registration request as the provisioning setting request, the first step may comprise a step of automatically designating a first retrieved one of the packages.

Thus, this enables an operator to perform a provisioning-setting of a service for a desired service offering device by a single input operation.

When it is found at the first step that there are a plurality of packages retrieved upon an automatic registration request as the provisioning-setting request, the first step may comprise a step of displaying a list enabling one of the packages to be designated.

This enables an operator to select a package which he/she wants while the input operation is increased by one time.

When it is found at the first step that there is no corresponding package retrieved, the first step may comprise a step of setting a storing reservation information of the packet in the first database.

This enables for example a lacking stock package to be retrieved based on storing reservation information set.

The above-noted third step may comprise steps of updating the provisioning information to a stored status, and of deleting stock information of the mounted package from the first database.

This enables unnecessary stock information to be eliminated from the first database and the storage capacity of the database to be always optimized.

This package stock management method may further comprise a fourth step of, upon a lacking stock information request, reading information of the package set with the storing reservation information from the first database.

Namely, with the storing reservation information as set in the above, lacking stock information can be obtained.

This package stock management method may further comprise a fifth step of, upon reception of a service revocation request concerning a specific package, retrieving provisioning information corresponding to the specific package from the second database to delete the provisioning information from the corresponding service offering device and to delete the provisioning information from the second database, and of setting storing reservation information concerning the deleted package in the first database.

This enables the provisioning setting information to be deleted from the package of the service offering device dispensing with a predetermined service, the package to be re-stored in the package storehouse, and the package being in a storing schedule to be set in the first database.

It is to be noted that while this “storing schedule” refers to a state up to where a package is stored in the package storehouse after service revocation, the above noted “storing reservation” refers to a state requiring a package to be stored because there is no package in the package warehouse.

This package stock management method may further comprise a sixth step of, upon reception of a package spare retrieval of the service offering device, retrieving the package to be displayed which is mounted on the service offering device from the second database, a seventh step of, upon reception of a package retrieval of same identifying information as the mounted package in response to the sixth step, outputting proper information of the package when a package of the identifying information is registered in the first database, and an eighth step of, upon any of the packages being designated in response to the seventh step, registering the package as a spare in the first database.

Thus, for the preparation of the case where a fault occurs in a presently moving service offering device, a package having the same identifying information (for example, package type) as a package mounted on the service offering device can be registered as a spare in the first database.

This package stock management method may further comprise a ninth step of, upon reception of a storing prediction read request, calculating statistic data to be acknowledged, based on the first database.

Namely, it is well-known that various statistic data can be calculated with the first database, so that the statistic data can be provided as an output upon reception of the storing prediction read request, thereby informing various stock status.

This package stock management method may further comprise a tenth step of, upon reception of an alarm notification from the mounted package, preliminarily registering information of the mounted package as alarm history information in the third database, and of, upon reception of a fault diagnosis request, outputting the alarm history information and information of a package of same identifying information as identifying information of a package where an alarm occurs, from the first and second databases.

Thus, it becomes possible to determine in what kind of package with an identifying information an alarm occurs.

A package stock management device which realizes the above-noted method according to present invention is characterized by comprising: a first means of, upon reception of a provisioning setting request of a service to a desired service offering device, retrieving a package having a necessary function for offering the service from stock information set in a first database; a second means of setting proper information of the retrieved package as provisioning information in a second database; and a third means of, at the time when the retrieved package is forwarded and mounted on the service offering device, setting the provisioning information in the mounted package.

When it is found by the first means that there are a plurality of corresponding packages retrieved upon an automatic provisioning setting request as the registration request, the first means may comprise a means of automatically designating a first retrieved one of the packages.

When it is found by the first means that there are a plurality of packages retrieved upon an automatic registration request as the provisioning setting request, the first means may comprise a means of displaying a list enabling one of the packages to be designated.

When it is found by the first means that there is no corresponding package retrieved, the first means may comprise a means of setting a storing reservation information of the packet in the first database.

The above-noted third means may comprise a means of updating the provisioning information to a stored status, and of deleting stock information of the mounted package from the first database.

This package stock management device may further comprise a fourth means of, upon a lacking stock information request, reading information of the package set with the storing reservation information from the first database.

This package stock management device may further comprise a fifth means of, upon reception of a service revocation request concerning a specific package, retrieving provisioning information corresponding to the specific package from the second database to delete the provisioning information from the corresponding service offering device and to delete the provisioning information from the second database, and of setting storing reservation information concerning the deleted package in the first database.

This package stock management device may further comprise a sixth means of, upon reception of a package spare retrieval of the service offering device, retrieving the package to be displayed which is mounted on the service offering device from the second database, a seventh means of, upon reception of a package retrieval of same identifying information as the mounted package from the sixth means, outputting proper information of a package when the package of the identifying information is registered in the first database, and an eighth means of, upon any of the packages being designated from the seventh means, registering the package as a spare in the first database.

This package stock management device may further comprise a ninth means of, upon reception of a storing prediction read request, calculating statistic data to be acknowledged, based on the first database.

This package stock management device may further comprise a tenth means of, upon reception of an alarm notification from the mounted package, preliminarily registering information of the mounted package as alarm history information in the third database, and of, upon reception of a fault diagnosis request, outputting the alarm history information and information of a package of same identifying information as identifying information of a package where an alarm occurs, from the first and second databases.

According to the present invention, upon provisioning-setting of a new service to a desired service offering device, an operator only has to perform the setting operation once or twice, so that the provisioning-setting operation can be rapidly performed.

Also, since the provisioning information is set in the service offering device at the time when the package is mounted on the service offering device, the service commencing time can be largely advanced.

Also, an operator can make an accurate storing prediction based on information of a lacking status of package or storing number prediction, whereby excessive package or stock insufficiency can be avoided. Further, it becomes possible to manage packages being stocked as a spare package for the preparation of faults, thereby realizing more effective stock management.

Furthermore, in the occurrence of package alarms, influences on services to be offered can be minimized without frequently causing the package alarms if packages having the same identifying information encounter common problems.

### BRIEF DESCRIPTION OF THE DRAWINGS

The above and other objects and advantages of the invention will be apparent upon consideration of the following detailed description, taken in conjunction with the involving drawings, in which the reference numerals refer to like parts throughout and in which:

FIG. 1 is a block diagram showing an embodiment which realizes a package stock management method and device according to the present invention;

FIG. 2A is a chart showing an embodiment of a processing sequence upon storing a package in a package stock management method and device according to the present invention;

FIG. 2B is a chart showing an embodiment of a package stock management database (status a) used in a package stock management method and device according to the present invention;

FIG. 3 is a chart showing a processing sequence upon setting services (at service provisioning-setting) in a package stock management method and device according to the present invention;

FIGS. 4A-4E are charts showing various databases per status used in the processing sequence shown in FIG. 3;

FIG. 5A is a chart showing an embodiment of a processing sequence of lacking stock list display in a package stock management method and device according to the present invention;

FIG. 5B is a chart showing an embodiment of package stock management database (status a) used in the processing sequence shown in FIG. 5A;

FIG. 6A is a chart showing an embodiment of a processing sequence upon service revocation in a package stock management method and device according to the present invention;

FIGS. 6B-6D are charts showing various databases per status used in the processing sequence shown in FIG. 6A;

FIG. 7A is a chart showing an embodiment of a processing sequence of stock package spare registration in a package stock management method and device according to the present invention;

FIGS. 7B-7D are charts showing various databases per status used in the processing sequence shown in FIG. 7A;

FIG. 8A is a chart showing an embodiment of a processing sequence of package store number prediction in a package stock management method and device according to the present invention;

FIG. 8B is a chart showing an embodiment of package stock management database (status a) used in the processing sequence shown in FIG. 8A;

FIG. 9A is a chart showing an embodiment of a processing sequence of package fault diagnosis in a package stock management method and device according to the present invention; and

FIG. 9B is a chart showing an embodiment of an alarm information database (status a) used in the processing sequence shown in FIG. 9A.

### DESCRIPTION OF THE EMBODIMENTS

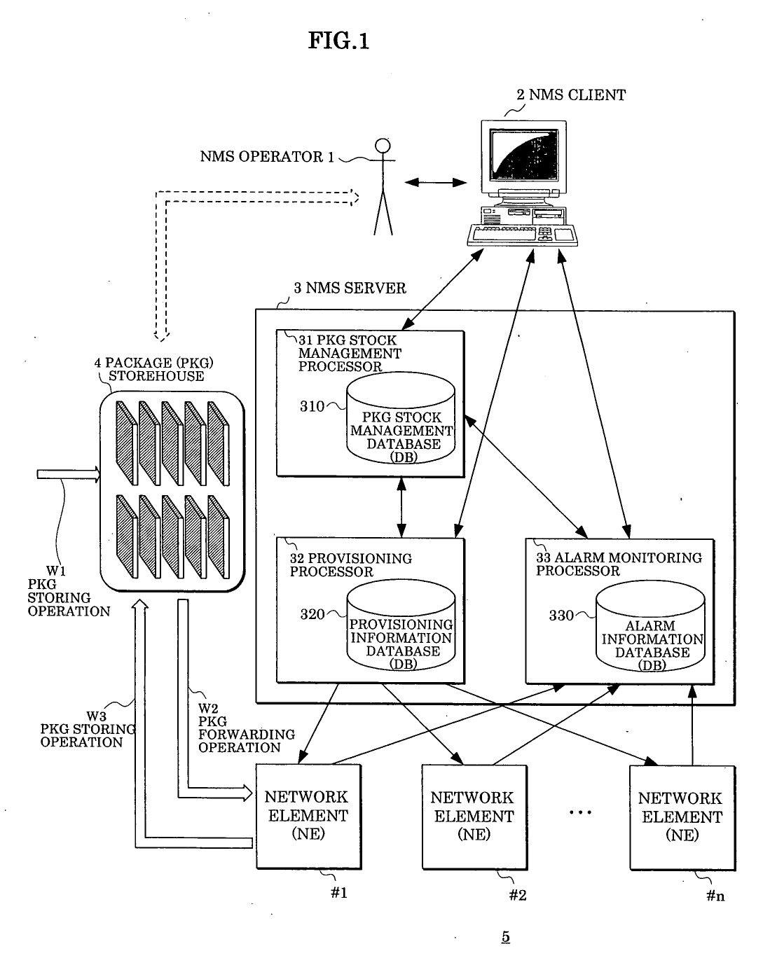

FIG. 1 shows one embodiment of a device for realizing a package stock management method according to the present invention, in which an NMS operator 1 is located at a client terminal 2, which is connected to a NMS server 3, which is connected to the client terminal 2 so as to be provided from the operator 1 with information of a stock status of packages stored in a package storehouse 4 by a storing operation W1. The NMS server 3 is connected to a communication (transmission) device 5 composed of n units of communication devices #1-#n. The communication device 5 mounts thereon a package forwarded from the package storehouse 4 by a forwarding operation W2, and stores a needless package in the package storehouse 4 by a storing operation W3.

The NMS server 3 includes a package stock management processor 31, a provisioning processor 32, and an alarm monitoring processor 33, in which these processors 31-33 are directly connected to a client terminal 2. The package stock management processor 31 is provided with a package stock management database (DB) 310, the provisioning processor 32 is provided with a provisioning information database 320, and the alarm monitoring processor 33 is provided with an alarm information database 330. The package stock management processor 31 is mutually connected to the provisioning processor 32 and the alarm monitoring processor 32. It is to be noted that the NMS server 3 corresponds to a package stock management device according to the present invention.

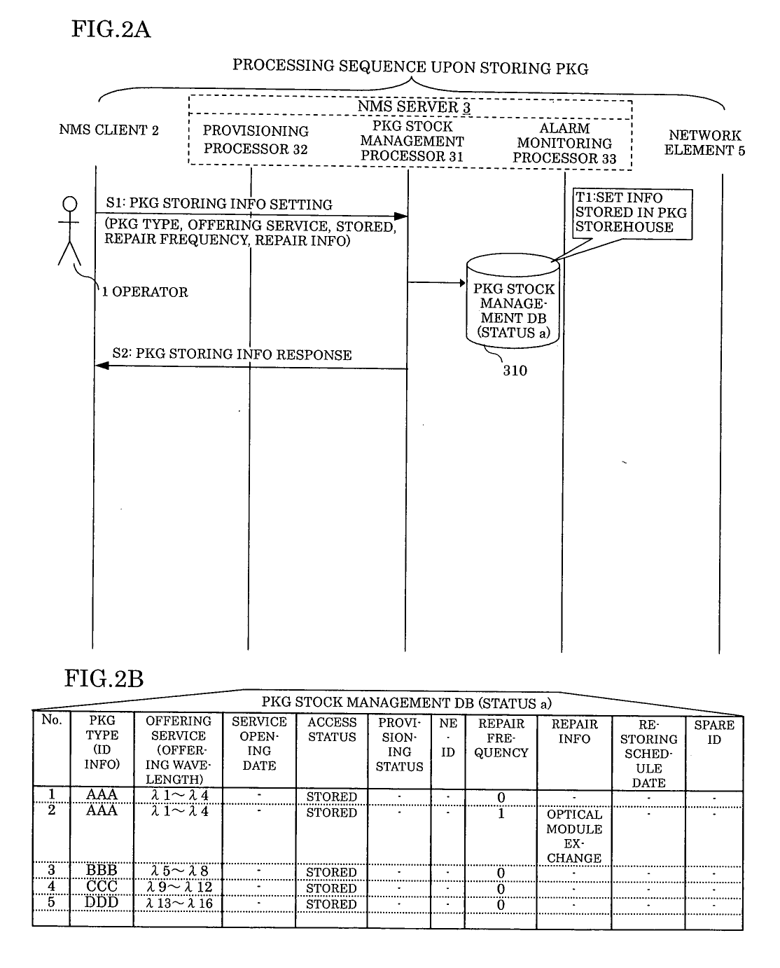

Hereinafter, an operation of the embodiment according to the present invention shown in FIG. 1 will be described referring to processings shown in FIG. 2 and the following. It is to be noted that “service” in the embodiments of the present invention refers to which wavelength is selected for the service in a case where the communication device adopts a light WDM system for example. It is also to be noted that “provisioning” as above noted means processing for setting such an offering service in a package mounted on the communication device 5, which is substantially equivalent to “registration” or “setting”.

Processing Upon Storing Package: FIG. 2

This processing shows a preparation process of the database 310 exhibiting what kind of package is stored in the package storehouse, by registering the information of a package as stored in the package storehouse 4 in the package stock management database 310.

At first, in FIG. 2A, the operator 1 provides the information of a package stored in the package storehouse 4 to the package stock management processor 31 in the server 3 (step S1). The setting information of this operation is, as shown, “package type”, “offering service”, “stored”, “repair frequency”, and “repairing information”. Upon reception of such package storing information, the package stock management processor 31 registers the same in the database 310 (step T1), thereby obtaining a package stock management database as shown in FIG. 2B. This embodiment illustrates a status “a” where five packages (number 1-5) have been stored in the package storehouse 4.

Thus, when the package storing information is registered in the database 310, the package stock management processor 31 returns an acknowledgment (ACK) to the effect that the information setting has been completed, to the client terminal 2 (step S2).

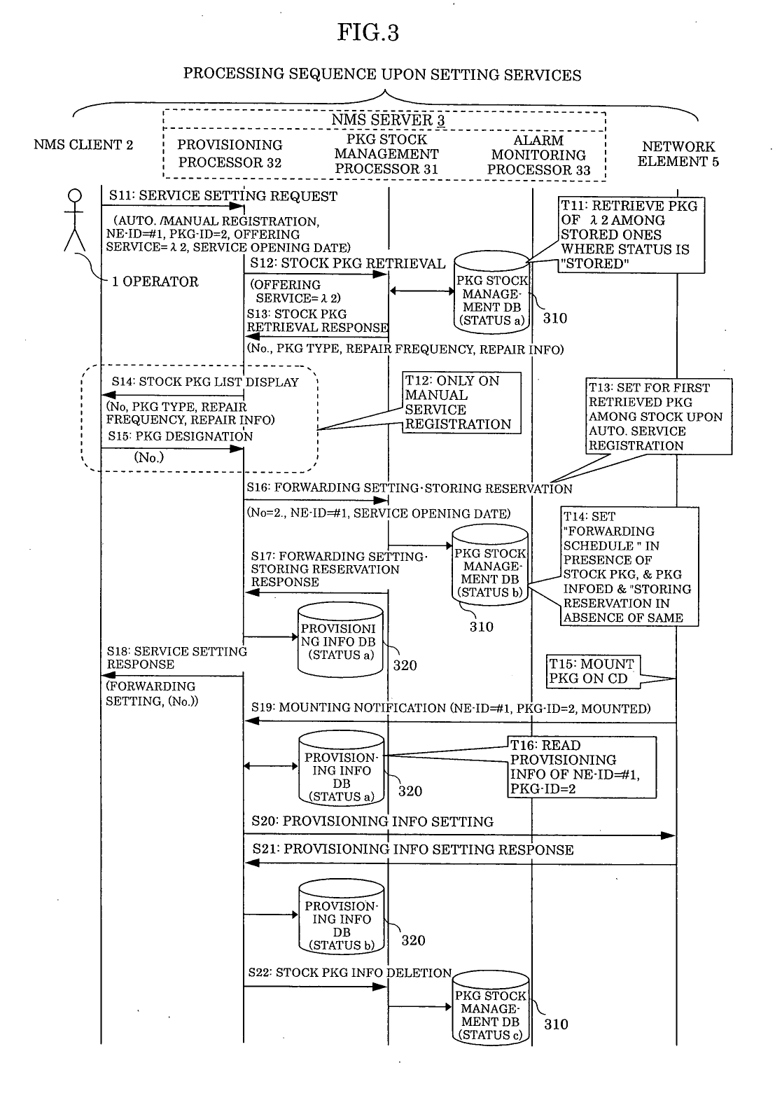

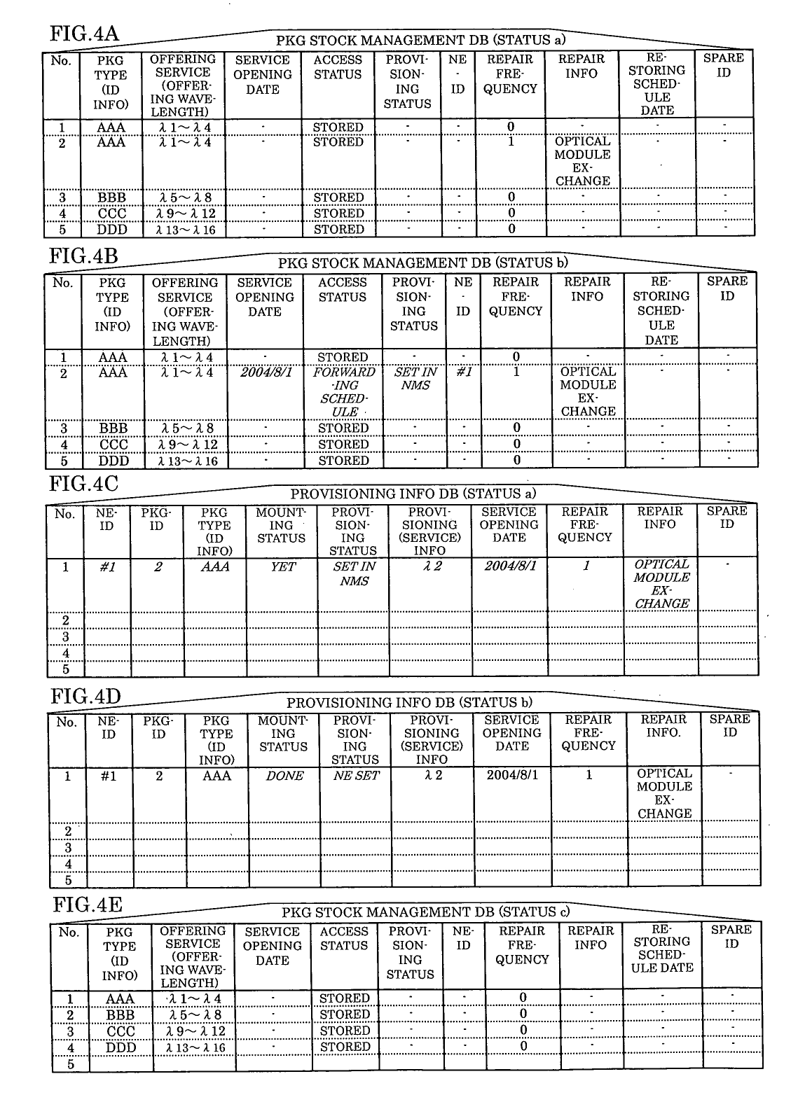

Processing Upon Setting Service: FIGS. 3 and 4

This processing shows a sequence of stock package retrieval processing and provisioning-setting processing upon registering a new service.

At first, the operator 1 makes a service setting request from the client terminal 2 to the provisioning processor 32 in the server 3 (step S11). This is a request for provisioning-setting of service information to a package required by the communication device 5 as above noted, in which a communication device ID (NE-ID)=#1, a package ID (PKG-ID)=2, an offering service=λ2, and the service opening date are requested to be set in this example. On this occasion, whether it is an automatic registration or manual registration is also requested. It is to be noted that the package ID indicates a position (slot position) of a package mounted on the communication device, so that the operator is to request in which slot position of which communication device a package should be mounted and set.

Thus, upon reception of the service setting request from the client terminal 2, the provisioning processor 32 performs a stock package retrieval to the package stock management processor 31 from among the service setting request information (step S12). In this embodiment, the package of the offering service=λ2 is to be retrieved from among the stock packages registered in the database 310 (step T11). The package stock management database 310 at this time is shown in FIG. 4A as a status “a”. This status “a” is the same as the status “a” in the package stock management database shown in FIG. 2B, where various statuses such as the status “a” do not always correspond to those in the following description.

As a result of the stock package retrieval to the package stock management processor 31 from the provisioning processor 32, the package of offering service=λ2 corresponds to packages No. 1 and No. 2 as shown from the status “a” in FIG. 4A, so that the package stock management processor 31 sends to the provisioning processor 32 the package type, repair frequency, and repair information of the packages No. 1 and No. 2 as the stock package retrieval acknowledgment (step S13).

Upon reception of such a stock package retrieval acknowledgment, the provisioning processor 32 displays a list of stock packages to the client terminal 2 as shown by dotted line step T12 (step S14), supposing that it has received request information of manual registration at the above noted step S11. This is to send the same information as an acknowledgment from the package stock management processor 31 at the above step S13. Upon reception of a list display of stock packages, the client terminal 2 designates a desired package among them (step S15). In this case, it is supposed that the package No. 2 is designated.

On the other hand, if the automatic registration is requested at step S11, the sequence will skip from step S13 to S16. While at step S15 the package No.2 is designated, it is supposed that a first retrieved package from among the stock packages is set in case of the automatic registration (step T13). Resultantly, the same package No.2 is to be designated. Them, at step S16, setting is made such that the package No.2 is forwarded or taken out of the package storehouse 4.

At the same time, the provisioning processor 32 provides to the package stock management processor 31 the information of a communication device ID=#1 and the service opening date among the service setting request information received at step S11. It is to be noted that the above forwarding setting assumes that the desired stock package No.2 is present in the package storehouse 4, in which the package stock management processor 31 sets “forwarding schedule” to the package stock management database 310 (step T14). This status “b” of the current database 310 is shown FIG. 4B, in which as shown by an italic character in the package No.2, the service opening date is set with “2004/8/1”, the access status is set with “forwarding schedule”, the provisioning status is set with “set in NMS”, and the communication ID is set with “#1”.

In the absence of a desired stock package in the package storehouse 4, proper (unique) information of the package and “storing schedule” are to be set (step T14), where this embodiment does not show them in the database 310 (status b) in FIG. 4B. Then, the processor 31 returns acknowledgment of the forwarding-setting or storing schedule to the processor 32 (step S17).

As a result, provisioning processor 32 sets the provisioning information database 320 to a status “a” shown in FIG. 4C. Namely, in the database 320, for the package No.1 subject to the provisioning-setting, the communication device ID=#1, the package ID=2, the package type=AAA, the mounting state=yet, the provisioning status=set in NMS (already set within NMS), the provisioning (service) information=λ2, the service opening date=2004/8/1, the repair frequency=1, and the repairing information=light optical module exchange are to be registered.

When the provisioning information is thus set in the database 320, the provisioning processor 32 returns an service setting acknowledgment to the client terminal 2 (step S18). For this acknowledgment information, information to the effect that the forwarding-setting has been done only has to be provided. In case where the automatic registration is selected at step S1, however, the package information (package No.) is also responded or acknowledged since the operator 1 does not know which package has been designated.

Upon reception of this service setting acknowledgment, the operator 1 forwards the corresponding package as above noted by the forwarding operation W2, and mounts the package on the communication device #1 at the slot of package ID=2, subject to the service setting request (step T15). As a result, from the communication device 5 a mounting notification is transmitted to the provisioning processor 32 (step S19). This mounting notification includes the information of the communication device ID=#1, the package ID=2, and “stored”.

Upon reception of the mounting notification, the provisioning processor 32 reads the provisioning information of the communication device ID=#1 and the package ID=2 as an object of the mounting notification from the status “a” of the provisioning information database 320 shown in FIG. 4C (step T14). As a result, it is found that the provisioning information (offering service information) of the package ID=2 to be mounted on the communication device ID=#1 is “λ2”, the repair frequency is “1”, the repairing operation is “optical module exchange”, and the service opening date is “2004/8/1”, so that the provisioning processor 32 sets the provisioning information in the communication device ID=#1 (step S20). The communication device 5 having received the provisioning information makes the provisioning-setting and returns the acknowledgment to the provisioning processor 32 (step S21).

Upon reception of the provisioning information setting acknowledgment, the provisioning processor 32 then updates the mounting state to “done” (already mounted) and the provisioning status to “NE set” (NE is already set) in the provisioning information database 320, as shown in status “b” of FIG. 4D. Together with this, since the proper information of the package having been subject to the provisioning-setting becomes needless, the provisioning processor 32 request the deletion of stock package information to the package stock management processor 31 (step S22), which responsively sets the database 310 to a status “c” in which the package No.2 in the status “a” shown in FIG. 4A is deleted as shown in FIG. 4E.

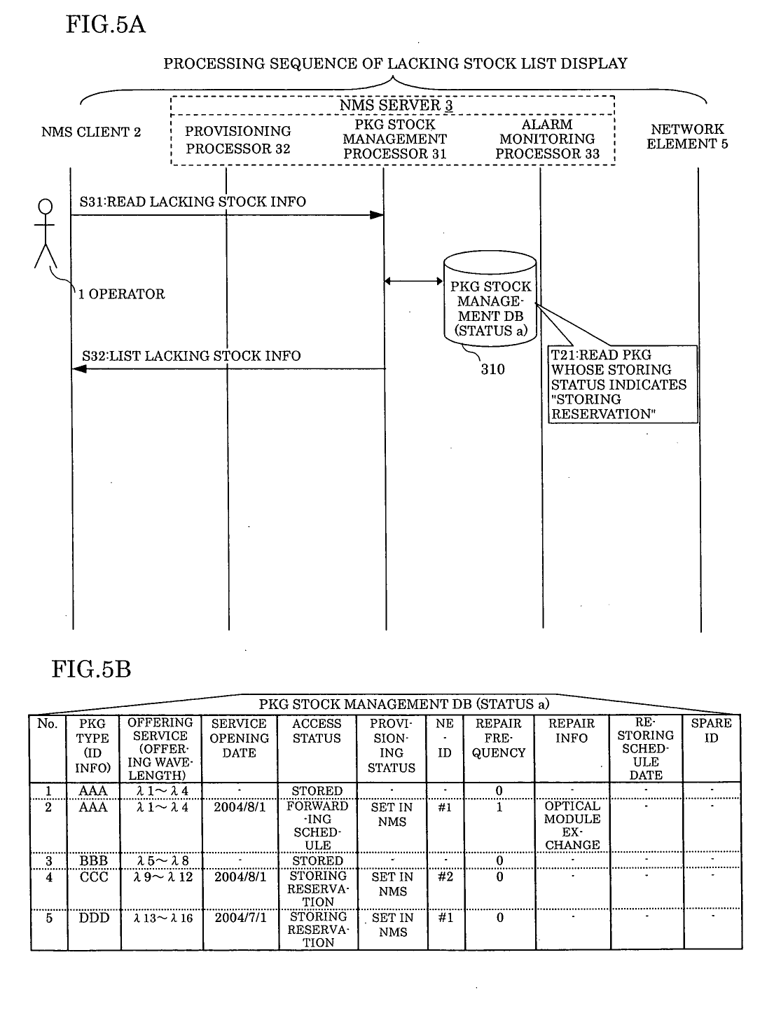

Processing of Lacking Stock List Display: FIG. 5

This processing provides a sequence by which the operator 1 determines at the package stock management database 310 what kind of package is lacking.

For this purpose, the operator 1 makes a read request of lacking stock information to the package stock management processor 31 in the server 3 from the client terminal 2 (step S31). As a result, the package stock management processor 31 reads a package whose access status is “storing schedule” from the database 310 (step T21). Since the packages No.4 and No.5 are set with “storing schedule” in the status “a” of the package stock management database 310 shown in FIG. 5B, the package information is displayed in the form of list to the operator 1 from the processor 31 through the client terminal 2 (step S32).

It is to be noted that “storing schedule” in the status “a” of the package stock management database 310 shown in FIG. 5B is set in the database 310 followed by the fact that “storing schedule” has been made in the absence of stock packages at step S16 in FIG. 3.

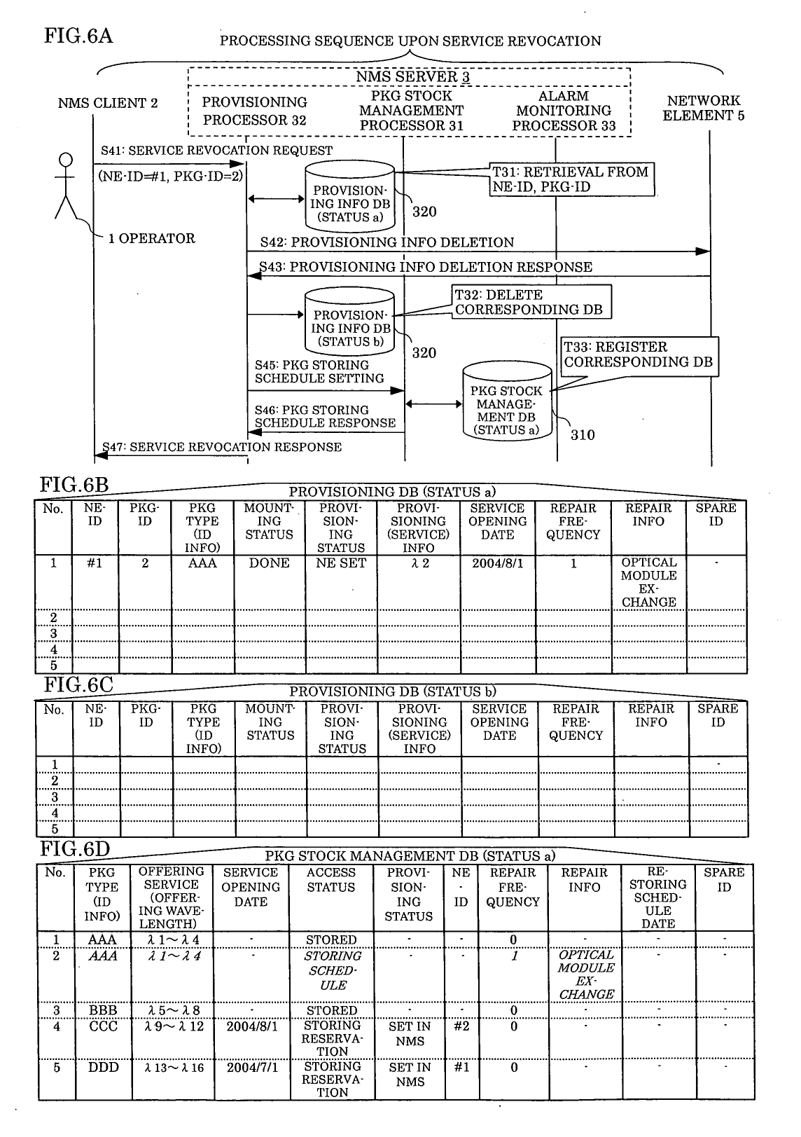

Processing of Service Revocation: FIG. 6

This processing shows a sequence of the deletion of the provisioning information and package storing processing when no service becomes required.

First of all, the operator 1 makes a service revocation request to the provisioning processor 32 in the server 3 from the client terminal 2 (step S41). This request information includes, for example, the communication device ID=#1 and the package ID=2 in order to request that a package in which slot position in which communication device should be abolished.

Upon reception of the request, the provisioning processor 32 retrieves the corresponding package from the provisioning information database 320 (step T31). Assuming that this provisioning information database 320 is set to a status “a” shown in FIG. 6B, which indicates that the package of the package ID=2 mounted on the communication device ID=#1 in the current service state is retrieved and is “mounted”, and the provisioning status is “NE set”, the provisioning processor 32 instructs the deletion of the information of the offering service=λ2 as the provisioning information to the communication device 5 (step S42). Accordingly, the communication device 5 deletes the service of the provisioning information=λ2, and returns the acknowledgment to the provisioning processor 32 (step S43).

This allows the provisioning processor 32 to delete all of the database of the corresponding package as shown in the status “b” of the provisioning information database 320 shown in FIG. 6C. The provisioning processor 32 then requests the package stock management processor 31 to set the proper information of the package deleted at the moment in the package stock management database 310 (step S45). As a result, the package stock management processor 31 is to make a storing schedule setting of the package No.2 as shown in the status “a” of the package stock management database 310 in FIG. 6D.

As a result, an acknowledgment of the package storing schedule setting is returned to the provisioning processor 32 from the package stock management processor 31 (step S46), so that the provisioning processor 32 makes a service revocation acknowledgment to the client terminal 2 (step S47). It is to be noted that this “storing schedule” refers to a status up to a storage of a package to the package storehouse 4 after the service revocation while the above noted “storing schedule” refers to a status requiring a storage because of no package in the package storehouse 4.

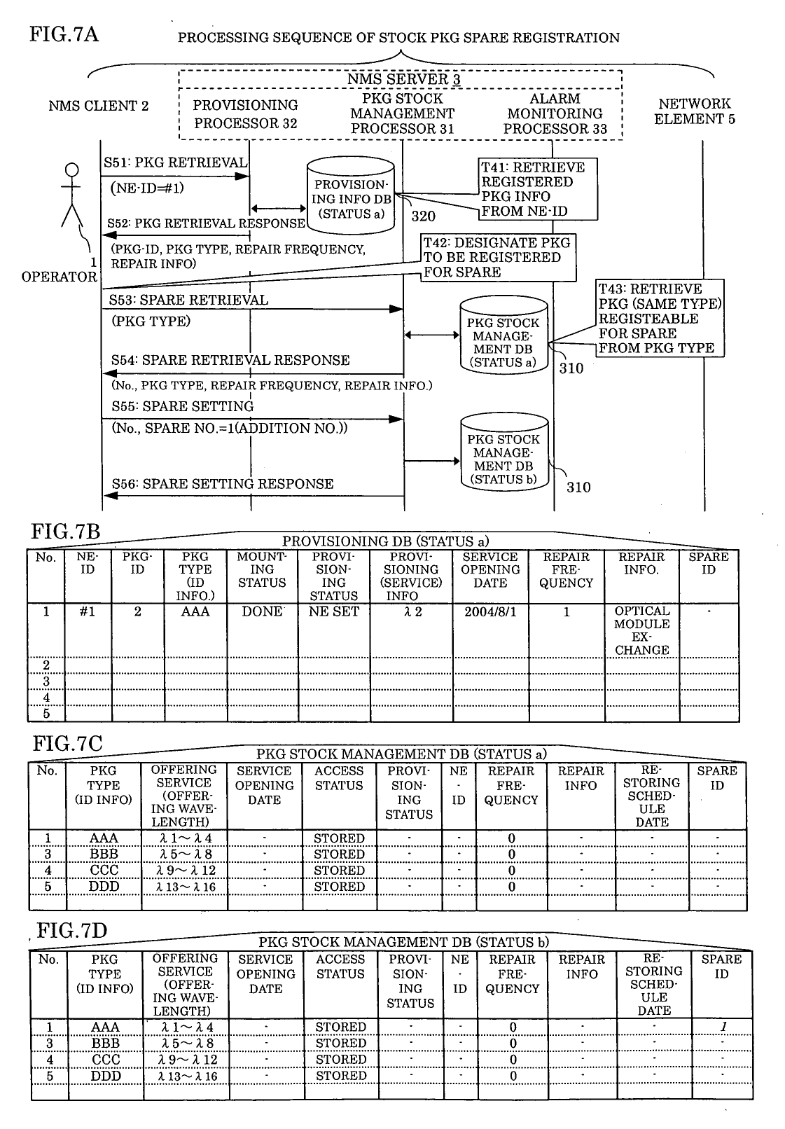

Processing of Stock Package Spare Registration: FIG. 7

This processing shows a sequence for previously registering a spare in preparation for a fault occurrence of a package mounted on the communication device at the moment.

At first, the operator 1 performs a package retrieval to the provisioning processor 32 of the server 3 from the client terminal 2 (step S51). This is supposed to be a package retrieval with respect to the communication device ID=#1 which the operator 1 knows. On this assumption, the provisioning processor 32 retrieves the proper information of the package in which the communication device ID=#1 is registered from the provisioning information database 320 (step T41), and returns the acknowledgment to the client terminal 2 (step S52). Now assuming that the provisioning information database 320 is registered to a status “a” shown in FIG. 7B, the information of the package ID=2, the package type=AAA, the repair frequency=1, and the repair information=optical module exchange is provided to the client terminal 2.

The operator 1 having received the package retrieval acknowledgment designates a package for a spare registration based on the same package type=AAA (step T42). In this embodiment, since only the package No.1 is registered in the database 320, it is to be designated. Then, a spare retrieval (package type=AAA) as to whether a package of the same type as the package designated is registered in the database 310 is performed to the package stock management processor 31 (step S53). As a result, the package stock management processor 31 finds that the package of the package type=AAA is the package No.1 in the status “a” of the package stock management database 320 as shown in FIG. 7C (step T43), so that the information of the package No.1 is returned to the client terminal 2 as the spare (step S54).

As a result, from the package stock management processor 31 to the client terminal 2, the information of the package No.2, the package type=AAA, the repair frequency=0, and the repair information=optical module exchange is provided, so that the operator 1 responsively performs the spare setting of the package No.2, spare number “1” to the package stock management processor 31 (step S55). In response, the package stock management processor 31 sets “1” to the spare ID with respect to the package No.1 as shown in the status “b” of the package stock management database in FIG. 7D, that is a spare setting. As a result, the package stock management processor 31 registers the status “b” in FIG. 7D in the package stock management database 310, and the setting acknowledgment is returned to the client terminal 2 (step S56).

Thus, it becomes possible to prepare a fault by setting a package of the same package type as the package currently mounted in the package stock management database 310 as a spare.

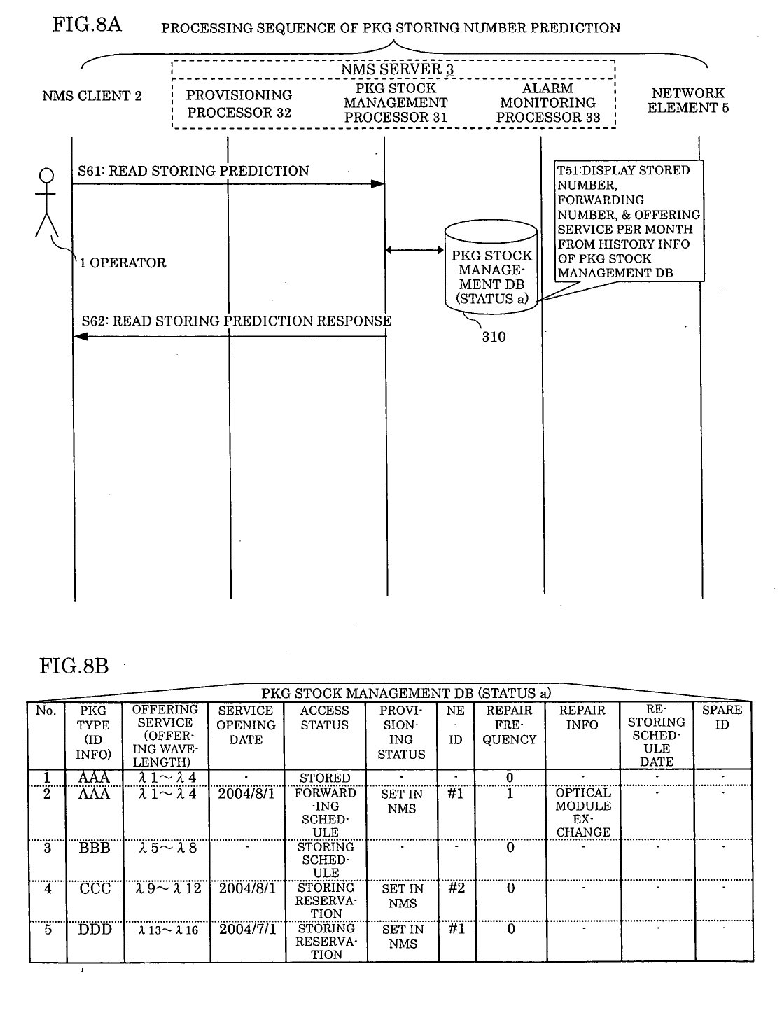

Processing of Package Storing Number Prediction: FIG. 8

This processing is to predict a storing number of package, in which the operator 1 performs a storing prediction reading to the package stock management processor 31 of the server 3 from the client terminal 2 (step S61). This allows the package stock management processor 31 to retrieve the history information of stored number, forwarding number, stock number, and service registration number per week/per month/per year of each package identifying information based on the status “a” of the package stock management database shown in FIG. 8B, to determine and display a list of statistic data and storing prediction number of the working month (step T51) per each package identifying information, and to respond to the client terminal 2 (step S62). In this case, the storing prediction number can be determined from statistic data of the current stock number, a package number in which a service opening date is set for the operating month, and forwarding number, by using a well-known algorithm.

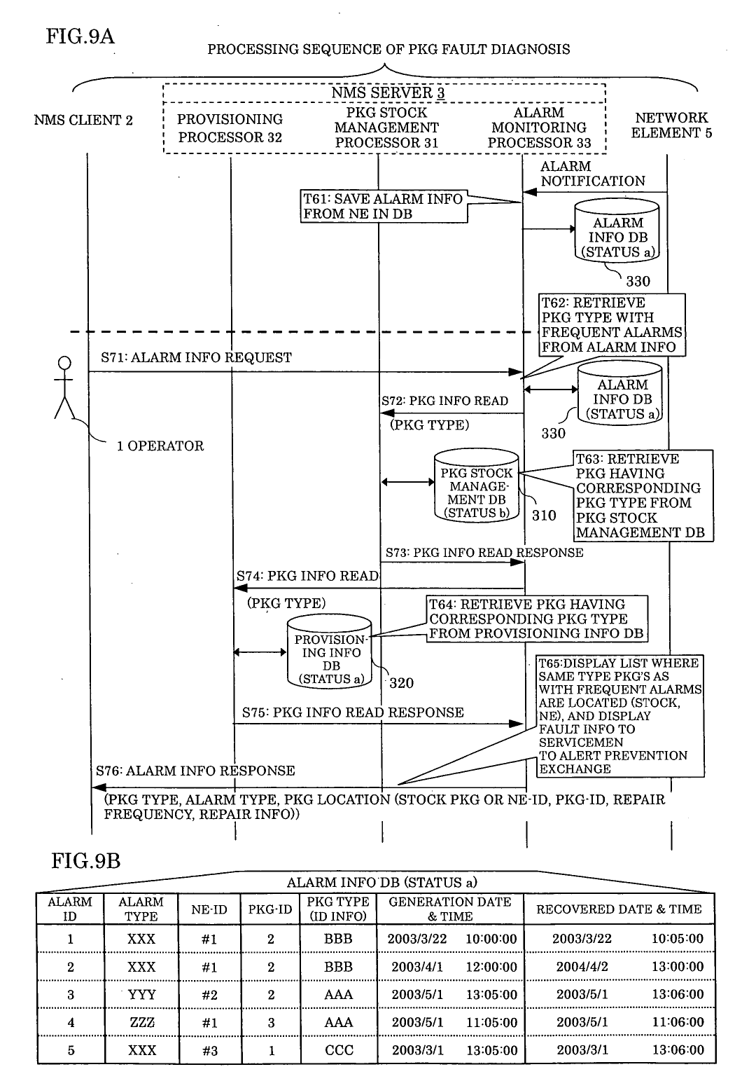

Processing of Package Fault Diagnosis: FIG. 9

In this package fault diagnosis processing, when an alarm notification in the communication device 5 is transmitted to the alarm monitoring processor 33 of the server 3, the alarm monitoring processor 33 previously accumulates data as a status “a” as shown in FIG. 9B in the alarm information database 330 (step T61).

In such a status, when the operator 1 requests alarm information to the alarm monitoring processor 33 from the client terminal 2 (step S71), the alarm monitoring processor 33 retrieves the type of the package where alarms are frequently generated, from the alarm information database 330 (step T62). This embodiment shows that packages of the package type=BBB, AAA frequently generate alarms.

Responsively, the alarm monitoring processor 33 reads the package information from the package stock management processor 31 based on the information of the package type “BBB” and “AAA” (step S72). In response, the package stock management processor 31 retrieves a package having the corresponding package type “BBB”, “AAA” from the package stock management database 310 (step T63), and acknowledges it to the alarm monitoring processor 33 (step S73).

Then, or at the same time, the alarm monitoring processor 33 reads the package information based on the same package type “BBB” and “AAA” from the provisioning processor 32 (step S74). The provisioning processor 32 responsively refers to the provisioning information database 320, retrieves a packet having the corresponding package type “BBB” and “AAA” (step T64), and acknowledges the same to the alarm monitoring processor 33 (step S75).

The alarm monitoring processor having received this package information reading acknowledgment (steps S73 and S75) makes an acknowledgment of the alarm information to the client terminal 2 (step S76). This acknowledgment is displayed in the form of a list where a package of the same type as the package type where alarms are frequently generated is located (stock, communication device, and the slot position), and displays fault information to the operator 1 to promote prevention effects (step T65).

1. A package stock management method comprising:
a first step of, upon reception of a provisioning setting request of a service to a desired service offering device, retrieving a package having a necessary function for offering the service from stock information set in a first database;
a second step of setting proper information of the retrieved package as provisioning information in a second database; and,
a third step of, at the time when the retrieved package is forwarded and mounted on the service offering device, setting the provisioning information in the mounted package.

2. The package stock management method as claimed in claim 1, wherein when it is found at the first step that there are a plurality of corresponding packages retrieved upon an automatic registration request as the provisioning setting request, the first step comprises a step of automatically designating a first retrieved one of the packages.

3. The package stock management method as claimed in claim 1, wherein when it is found at the first step that there are a plurality of packages retrieved upon an automatic registration request as the provisioning setting request, the first step comprises a step of displaying a list enabling one of the packages to be designated.

4. The package stock management method as claimed in claim 2, wherein when it is found at the first step that there is no corresponding package retrieved, the first step comprises a step of setting a storing reservation information of the packet in the first database.

5. The package stock management method as claimed in claim 2, wherein the third step comprises steps of updating the provisioning information to a stored status, and of deleting stock information of the mounted package from the first database.

6. The package stock management method as claimed in claim 4, further comprising a fourth step of, upon a lacking stock information request, reading information of the package set with the storing reservation information from the first database.

7. The package stock management method as claimed in claim 1, further comprising a fifth step of, upon reception of a service revocation request concerning a specific package, retrieving provisioning information corresponding to the specific package from the second database to delete the provisioning information from the corresponding service offering device and to delete the provisioning information from the second database, and of setting storing reservation information concerning the deleted package in the first database.

8. The package stock management method as claimed in claim 1, further comprising a sixth step of, upon reception of a package spare retrieval of the service offering device, retrieving the package to be displayed which is mounted on the service offering device from the second database, a seventh step of, upon reception of a package retrieval of same identifying information as the mounted package in response to the sixth step, outputting proper information of the package when a package of the identifying information is registered in the first database, and an eighth step of, upon any of the packages being designated in response to the seventh step, registering the package as spare in the first database.

9. The package stock management method as claimed in claim 1, further comprising a ninth step of, upon reception of a storing prediction read request, calculating statistic data to be acknowledged, based on the first database.

10. The package stock management method as claimed in claim 1, further comprising a tenth step of, upon reception of an alarm notification from the mounted package, preliminarily registering information of the mounted package as alarm history information in the third database, and of, upon reception of a fault diagnosis request, outputting the alarm history information and information of a package of same identifying information as identifying information of a package where an alarm occurs, from the first and second databases.

11. A package stock management device comprising:
a first means of, upon reception of a provisioning setting request of a service to a desired service offering device, retrieving a package having a necessary function for offering the service from stock information set in a first database;
a second means of setting proper information of the retrieved package as provisioning information in a second database; and,
a third means of, at the time when the retrieved package is forwarded and mounted on the service offering device, setting the provisioning information in the mounted package.

12. The package stock management device as claimed in claim 11, wherein when it is found by the first means that there are a plurality of corresponding packages retrieved upon an automatic provisioning setting request as the registration request, the first means comprises a means of automatically designating a first retrieved one of the packages.

13. The package stock management device as claimed in claim 11, wherein when it is found by the first means that there are a plurality of packages retrieved upon an automatic registration request as the provisioning setting request, the first means comprises a means of displaying a list enabling one of the packages to be designated.

14. The package stock management device as claimed in claim 12, wherein when it is found by the first means that there is no corresponding package retrieved, the first means comprises a means of setting a storing reservation information of the packet in the first database.

15. The package stock management device as claimed in claim 12, wherein the third means comprises a means of updating the provisioning information to a stored status, and of deleting stock information of the mounted package from the first database.

16. The package stock management device as claimed in claim 14, further comprising a fourth means of, upon a lacking stock information request, reading information of the package set with the storing reservation information from the first database.

17. The package stock management device as claimed in claim 11, further comprising a fifth means of, upon reception of a service revocation request concerning a specific package, retrieving provisioning information corresponding to the specific package from the second database to delete the provisioning information from the corresponding service offering device and to delete the provisioning information from the second database, and of setting storing reservation information concerning the deleted package in the first database.

18. The package stock management device as claimed in claim 11, further comprising a sixth means of, upon reception of a package spare retrieval of the service offering device, retrieving the package to be displayed which is mounted on the service offering device from the second database, a seventh means of, upon reception of a package retrieval of same identifying information as the mounted package from the sixth means, outputting proper information of a package when the package of the identifying information is registered in the first database, and an eighth means of, upon any of the packages being designated from the seventh means, registering the package as a spare in the first database.

19. The package stock management device as claimed in claim 11, further comprising a ninth means of, upon reception of a storing prediction read request, calculating statistic data to be acknowledged, based on the first database.

20. The package stock management device as claimed in claim 11, further comprising a tenth means of, upon reception of an alarm notification from the mounted package, preliminarily registering information of the mounted package as alarm history information in the third database, and of, upon reception of a fault diagnosis request, outputting the alarm history information and information of a package of same identifying information as identifying information of a package where an alarm occurs, from the first and second databases.
